(19) United States
(12) Patent Application Publication
(10) Pub. No.: US 2025/0276388 A1
(43) Pub. Date: Sep. 4, 2025

(54) DEVICE FOR DRILLING CENTERED HOLES

(71) Applicants: Anthony A. Cucuzza, Colorado Springs, CO (US); Vincent A. Cucuzza, Colorado Springs, CO (US)

(72) Inventors: Anthony A. Cucuzza, Colorado Springs, CO (US); Vincent A. Cucuzza, Colorado Springs, CO (US)

(21) Appl. No.: 19/070,052

(22) Filed: Mar. 4, 2025

Related U.S. Application Data
(60) Provisional application No. 63/561,243, filed on Mar. 4, 2024.

(51) Int. Cl. B23B 47/28

(52) U.S. Cl. CPC B23B 47/287

(57) ABSTRACT

Disclosed are tools for creating holes in precise locations for alignment on two different sides of an object, such as a strut or beam. Precise alignment of the holes allows for support of the object using a connecting bolt. Oversized holes can be corrected using an insert with an opening of the proper size. Precisely located holes can also be provided in angled materials, such as angled trusses and beams.

### BACKGROUND

Metal truss connector plates are frequently used to secure trusses or timbers in a building. These trusses are often decorative but also provide structural stability. It is oftentimes difficult to drill holes that are centered on metal truss connector plates so that bolts connecting metal truss connector plates on two sides of the trusses are supported by the wood surfaces inside the drilled holes.

### SUMMARY

A tool for boring a final hole in a truss, having a final diameter, that is coaxial with a centerline between a first location on a first side of a truss and a second location on a second side of the truss comprising: a pilot rod that has a diameter that is less than the final diameter; a first template placed on a first side of the truss, and secured to the truss, that provides the first location on the first side of the truss; a second template placed on a second side of the truss, and secured to the truss, that provides the second location on the second side of the truss; a pilot bit secured to a drill that is adapted to create a wobbled hole in the truss between the first location and the second location that is sufficiently large to allow the pilot rod to extend through the wobbled hole from the first location to the second location; a borer mounted coaxially with the pilot rod, the borer having a diameter that is the same as the final diameter, the borer adapted to bore the final hole in the truss that is coaxial with the centerline between the first location and the second location.

A method of forming a final hole in a truss that is coaxial with a centerline between a first location, on a first side of the truss, and a second location on a second side of the truss comprising: using a first template on the first side of the truss to place at least one opening in the template at the first location on the first side of the truss, and a second template on the second side of the truss to place at least one opening in the second location on the second side of the truss; drilling a first pilot hole at the first location on the first side of the truss using a pilot bit, the pilot hole having a first diameter that is less than a final diameter of a final hole; connecting the first pilot hole so that a pilot rod can extend from the first location to the second location through a wobbled hole; extending a pilot rod, that is coaxially connected to a borer, from the first template to the second template through the wobbled hole; placing a bushing in the first template, so that the borer is located on the centerline at the first location when the borer is located in the bushing, and the pilot rod placing the borer on the centerline of the second location when the pilot rod is located in the second template, the bushing allowing the borer to rotate and form the final hole, that is not wobbled, and has a consistent diameter in the truss.

### BRIEF DESCRIPTION OF THE DRAWINGS

FIG. 1 is a side view of a truss structure and a metal truss connector plate.

FIG. 2 is a side view illustrating components of the present invention.

FIG. 3 is another side view illustrating components of the present invention.

FIG. 4 is an isometric view illustrating the operation of the present invention.

FIG. 5 is another isometric view illustrating components of the present invention.

FIG. 6 is an isometric view illustrating a template, bushing, and hole saw.

FIG. 7 is an isometric view illustrating two templates, a bushing, and a hole saw.

FIG. 8 is another isometric view illustrating two templates and a hole saw.

FIG. 9 is a side view illustrating the manner in which a hole saw, saws a centered hole in truss 112.

FIG. 10 is an isometric view illustrating the manner in which a hole saw, saws a hole in a truss.

FIG. 11 shows the manner in which an insert is used with an oversized hole in a truss.

FIG. 12 is an isometric view of a truss having a wobbled hole.

FIG. 13 is an isometric view of the manner in which a hole saw can be used to remove a wobbled hole.

FIG. 14 is a side view illustrating the manner in which angled templates can be used to drill holes in an angled truss.

### DETAILED DESCRIPTION OF THE EMBODIMENTS

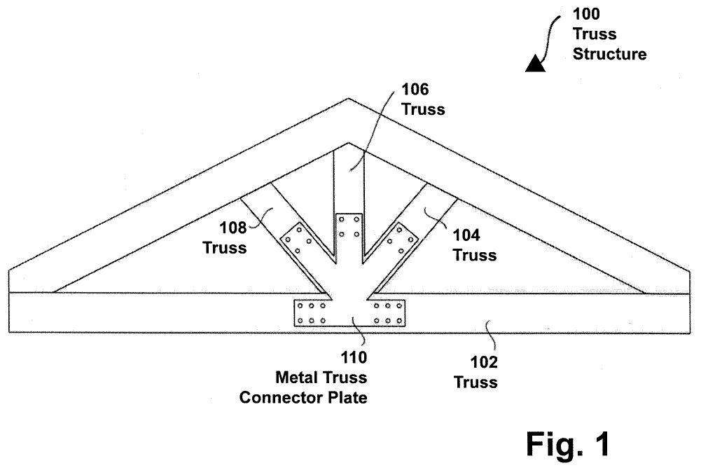

FIG. 1 illustrates a series of trusses 102, 104, 106, 108 that are attached by using a metal truss connector plate 110. An identical plate is placed on the other side of the trusses 102-108 and bolts are used to through-bolt the metal truss connector plate 110 to another identical metal truss connector plate on the other side of the trusses 102-108. Although the system shown uses metal truss connector plates, such as metal truss connector plate 110, to attach wooden trusses 102-108, the process of drilling holes from one side of an object, to an exact location on another side of the object, can be used for various applications. For example, the trusses 102-108 do not necessarily need to be wooden trusses, but can be any type of material or other object. In addition, the process disclosed herein can be used to precisely bore holes from one location on one side of an object to a specified location on an opposite side of the object with a high degree of precision. In addition, the present application refers to sawing, drilling, routing, auguring, or other forms or methods of creating a hole in various types of materials. All of these techniques are referred to as “boring,” which is performed by a “bore” that can comprise a drill, an auger, a hole saw, or other similar tool. For purposes of illustration, the figures herein show a hole saw, but any desired type of bore can be used.

In order to properly drill holes in the trusses to gain maximum support, the holes must be aligned with the openings in the metal truss connector plates on each side of the trusses 102-108. In this way, a bolt that is placed through one metal truss connector plate through the truss can then extend out of a corresponding hole in another metal truss connector plate. A tight hole in the truss, that engages a through-bolt, provides support between the metal truss connector plate 110, trusses 102-108 and another identical plate on the other side of the trusses, since the bolt is tightly surrounded by the wood of the trusses 102-108 and aligned with the openings in the metal truss connector plate 110. If the bolts do not fit tightly in the trusses because the holes are too big or wobbled to align with the openings in the metal truss connector plates, less structural support will be provided and movement of the trusses 102-108 may result. The metal truss connector plate 110 has twenty-four openings that require holes for bolts that must be connected directly through the twenty-four openings to a similar metal truss connector plate on the other side of the trusses 102-108. As such, twenty-four holes must be drilled that align precisely, center-to-center with the openings in the two metal truss plates so that there is no additional space around each of the bolts in the trusses.

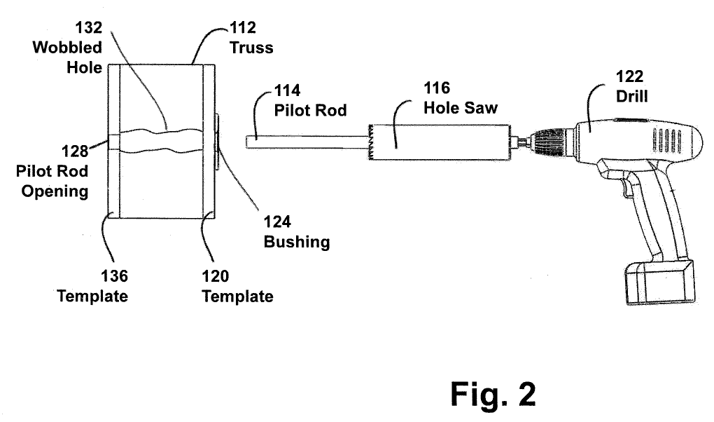

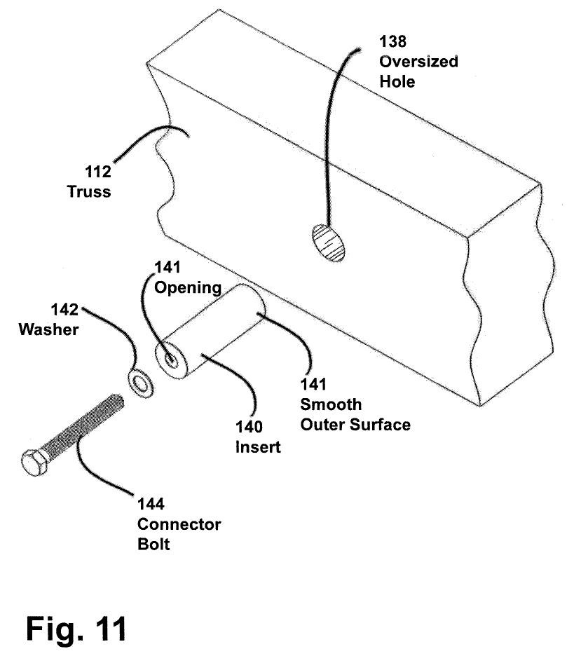

FIG. 2 is a side view illustrating one embodiment for boring a hole in a truss or beam 112 that fits tightly around a bolt placed through the hole. As illustrated in FIG. 2, a drill 122 is connected to a hole saw 116 and pilot rod 114. Templates 136, 120 are placed on the truss 112 and secured to the truss 112. Template 136 may comprise a metal truss connector place 110, such as illustrated in FIG. 1, or a metal or wood template. A pilot hole is initially drilled through truss 112. The pilot hole may have the same diameter as the pilot rod 114 or a slightly greater diameter. Since it is difficult to drill center to center with a pilot hole, a wobbled hole 132 may be created. A wobbled hole 132 is created by drilling a hole that is smaller than the diameter of the connecting bolt 144 (FIG. 11), i.e., a hole that is the same diameter or slightly larger diameter than the pilot rod 114. The wobbled hole can be made by drilling the pilot bit from one side or both sides of truss 112. A larger hole can then be bored by the hole saw 116 that exactly fits the size of the through bolt 114. For purposes of the explanation of FIG. 2, template 136 is a template having a pilot rod opening 128, which is the size of the pilot rod 114. The wobbled hole 132 is created by drilling from one side of truss 112 or by drilling halfway, or more than halfway, from each side of the truss 112 and wobbling the drill bit around until the drill bit can be passed through the template 120 and through the template 136. The drill bit is a drill bit that has a diameter that is smaller than the diameter of the connecting bolt 144. For purposes of describing FIG. 2, and by example only, the drill bit may constitute a ¼″ diameter drill bit. The pilot rod 114 may be a ¼″ diameter pilot rod or slightly smaller to ensure proper rotation. Pilot rod 114 is mounted co-axially with hole saw 116 in any desired fashion by bolting, welding, etc. Again, the term “hole saw” is considered to be generic for auger, borer, cutter, grinder, etc. The hole saw 116 may be a ¾″ diameter hole saw that drills a ¾″ diameter hole in the truss 112. The bolts that are used to connect the metal truss connector plates on each side of the truss, in this example, are ¾″ bolts so that the bolts fit tightly in the hole drilled in the truss 112. The template 136 is placed on the truss 112 so that the pilot rod opening 128 is centered on the opening of the metal truss connector plate 110 illustrated in FIG. 1. Of course, a template 136 may contain twenty-four different pilot rod openings 128, or other number, which are centered on each of the openings in the metal truss connector plate 110. Once the wobbled hole 132 is made large enough to fit the pilot rod 114 through the bushing 124, through the wobbled hole to the pilot rod opening 128, the pilot rod 114 and hole saw 116 can be rotated by the drill and pushed through the truss 112 until the hole saw 116 is aligned with an opening in the bushing 124. Then, the hole saw 116 can be passed through the bushing 124 that has an opening that is approximately the same diameter as the hole saw 116, with the pilot rod centered in the pilot rod opening 128. In this manner, a hole saw 116 can saw through the truss 112. In this example, the hole saw 116 is the same diameter as the connector bolt 144 (FIG. 11) which will be placed through the hole that is sawed in the truss 112. In the present example, the hole saw has a diameter of ¾″ and the bolt has a diameter of ¾″. Of course, these are only examples and various size holes, drill bits, and connector bolts can be used.

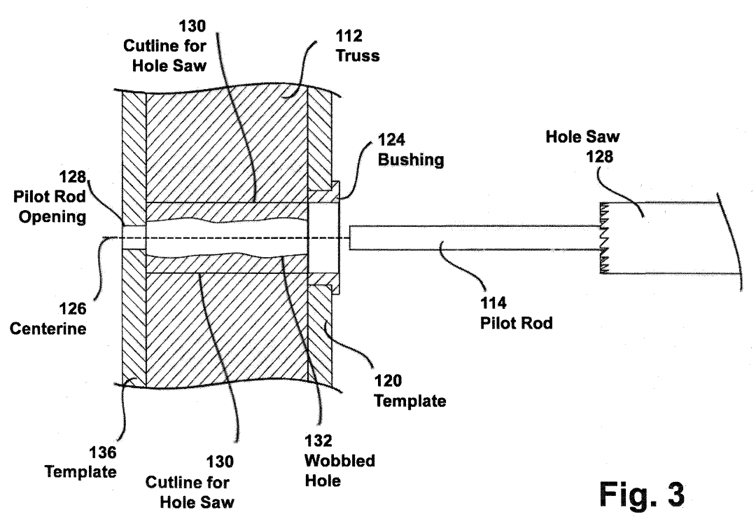

FIG. 3 is a close-up cross-sectional view of FIG. 2. As shown in FIG. 3, the bushing 124 has an opening that is the same diameter as the hole saw 128 or slightly larger to allow rotation of the hole saw 128 in bushing 124. The bushing 124 is mounted in the template 120, which is placed on the truss 112 so that the bushing 124 is centered on the metal truss connector plate 110 opening. The pilot rod 114 slides through the wobbled hole 132, which was made by wobbling a drill bit on a drill through the openings on either side or both sides of the truss 112. The pilot rod 114 slides through the truss 112 to a pilot rod opening on template 136. The pilot rod opening 128 is centered on the location of the centerline for the opening in the metal truss connector plate 110. Cutline 130 illustrates the manner in which the wobbled hole is removed. As is clear from FIG. 3, all of the wobbled hole 132 is removed by the hole saw 128 so that a smooth hole is created that has a uniform diameter and is centered on centerline 126. In each example illustrated herein, the templates, such as templates 120, 136, are secured to the truss. The templates can be clamped in place or secured by any desired method.

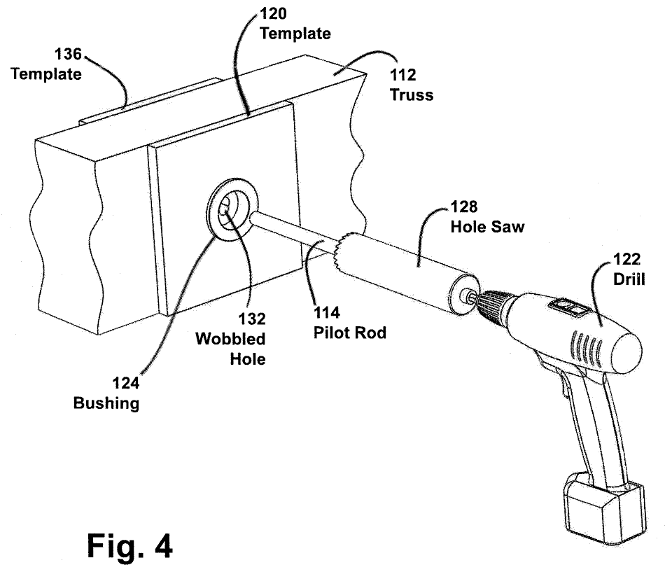

FIG. 4 is an isometric view of the device of FIG. 3. As shown in FIG. 4, template 120 has a bushing 124 that is placed in the template 120. The bushing 124 has an opening diameter that is the same diameter or slightly larger than the diameter of the hole saw 128 so that the hole saw fits through the opening in bushing 124 and can rotate easily. Template 136 is mounted on the opposite side of the truss 112. Pilot rod 114 extends through the wobbled hole 132 and is aligned with the pilot rod opening 128 (FIG. 3) in template 136. The hole saw passes through the opening in the bushing 124 and saws a hole in the truss 112, in response to rotation by drill 122. The hole saw 128 is centered on the openings of the metal truss connector plates on each side of the truss 112.

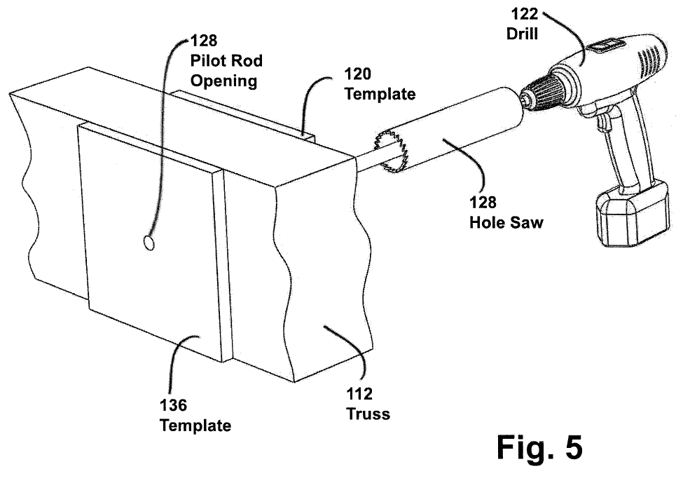

FIG. 5 is an isometric view of FIG. 4 from an opposite side of the truss 112. As shown in FIG. 5, the template 136 has a pilot rod opening 128. The template 136 is placed on the truss 112 so that the pilot rod opening 128 is centered on the metal truss connector plate 110 opening, as illustrated in FIG. 1. Multiple pilot rod openings may be provided in template 136 that are aligned with the centerline of each of the openings of the metal truss connector plate on the opposite side of truss 112 so that drill 122 can rotate hole saw 128 along the centerline of bushing 124 and pilot rod opening 128. As such, the template 136 may contain holes, e.g., twenty-four holes, such as shown in FIG. 1.

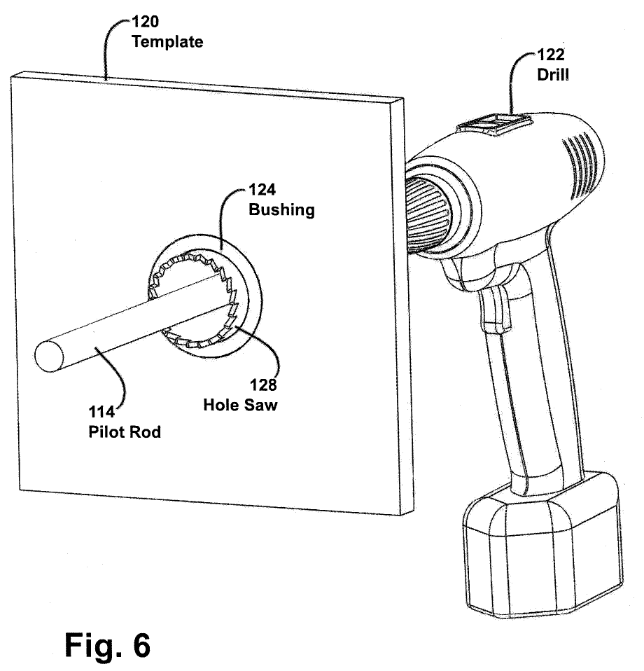

FIG. 6 is an isometric view that illustrates the hole saw 128 and pilot rod 114 extending through the bushing 124 of template 120. Drill 122 is connected to the hole saw 116 and pilot rod 114 assembly, and rotates the hole saw 128 and pilot rod 114 in the bushing 124 so that the hole saw saws a hole in the truss 112 (FIG. 5).

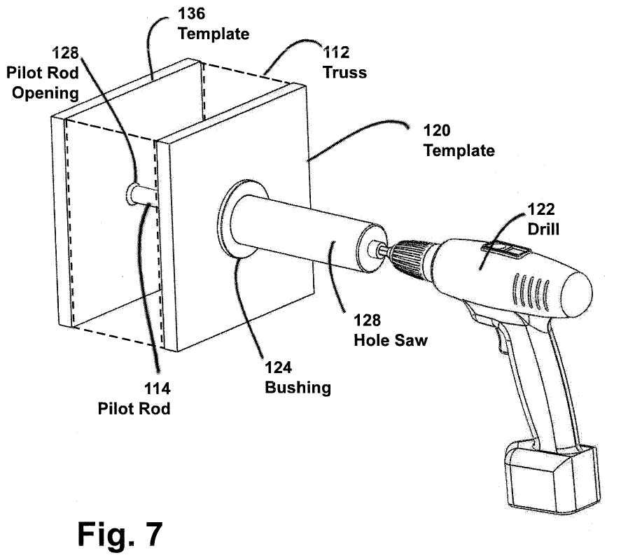

FIG. 7 is another isometric view of the hole saw 128 and pilot rod 114 assembly that extends through the bushing 124 in template 120 and through pilot rod opening 128 and template 136. As illustrated in FIG. 7, pilot rod 114 fits within the pilot rod opening 128 to center the pilot rod and the hole saw 128 with template 136. Bushing 124 and template 120 centers the hole saw 128, which is rotated by drill 122 in template 120.

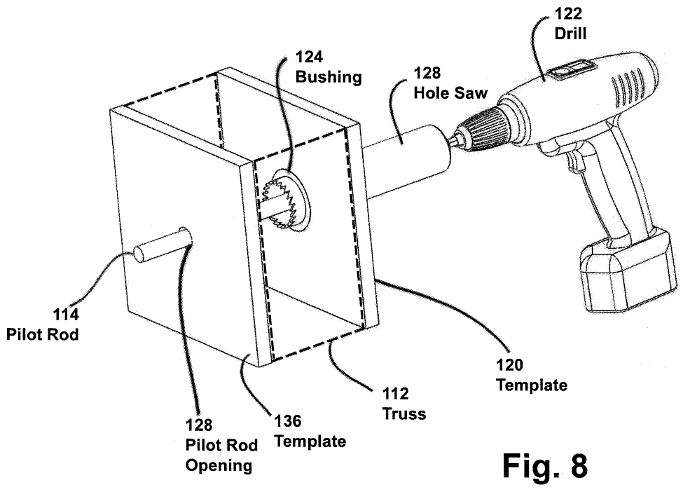

FIG. 8 is another isometric view illustrating the manner in which the pilot rod 114 and hole saw 128 assembly fit through templates 136, 120, respectively. Pilot rod 114 extends through the pilot rod opening 128 while the hole saw 128 extends through bushing 124. Drill 122 rotates the hole saw 128 and pilot rod 114 assembly to drill a centered hole in the truss 112.

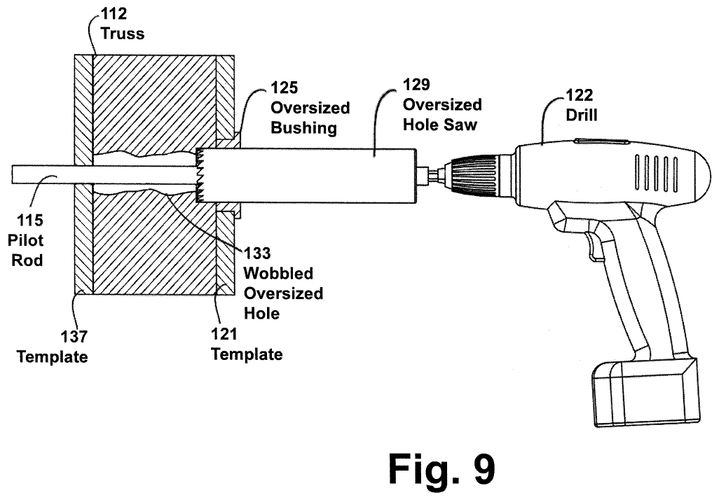

FIG. 9 illustrates an alternative embodiment of the embodiments shown in FIGS. 1-8. In accordance with the embodiment of FIG. 9, truss 112 has been drilled with a wobbled oversized hole 133 that is larger than the size of the bolt that is intended to connect metal truss connector plate 110 to a similar metal truss connector plate on the other side of the truss, as illustrated in FIG. 1. In other words, wobbled oversized hole 133, in accordance with the example given with respect to FIGS. 2 and 3, is not a wobbled hole that is made from a drill bit that is smaller than the diameter of the connector bolt 144 (FIG. 11), but rather, is an attempt to drill a full sized hole having the same diameter as the diameter of the connector bolt 144 center-to-center for the holes of the metal truss connector plates 110 and the opposite metal truss connector plate on the truss. The full size hole is not drilled on the centerline, and has been wobbled to allow the bolt to go through the openings on the two metal truss connector plates on opposite sides of the truss 112. For example, and by way of example only, if a ¾″ diameter bolt is intended to be used to connect the metal truss connector plates, the wobbled oversized hole 132 would be larger than the ¾″ diameter of the connector bolt 144. Although the ¾″ diameter bolt could be used to connect the two metal truss connector plates on each side of the truss 112, the wooden structure of the truss 112 would not be supported by the connector bolt 144. To save the truss 112, the technique illustrated in FIGS. 9-14 can be used.

As illustrated in FIG. 9, a hole saw 128, which has a diameter that is greater than the size of the wobbled oversized hole 132, and the connecting bolt 144 can be used. In that regard, in the previous example of FIGS. 1 and 2, the hole saw 128 is a ¾″ hole saw since the wobbled hole 132 was made by a smaller drill having a diameter of ¼″. In the present example, the hole saw 128 may have a 1″ diameter, since the wobbled oversized hole 132 was made by a ¾″ diameter drill bit. In the previous example of FIGS. 1 and 2, prior planning was used to drill a wobbled hole that has a smaller diameter than the diameter of the bolt to be used, i.e., ¾″ bolt. However, in the example shown in FIG. 9, there was no advanced planning and the user simply attempted to drill a full sized hole on a centerline between two metal truss connector plates on opposite sides of the truss 112. Since it is nearly impossible for the person to drill a single hole that is aligned perfectly on a centerline between the openings of metal truss connector plates on opposite sides of the truss 112, the hole must be wobbled with the full sized drill bit to create a wobbled oversized hole 132. Some contractors would simply use the wobbled oversized hole 132 and not be concerned that the truss 112 was not properly supported between the metal truss connector plates on each side of the truss 112. Using the wobbled oversized hole 132 will result in lack of structural support of the truss 112 and can lead to movement and failure of the truss structure illustrated in FIG. 1.

In order to remedy this situation, the hole saw 128, as mentioned previously, can be a larger size, such as a 1″ hole saw, that cuts a hole in the truss 112 along a centerline that aligns the openings in the metal truss connector plates on each side of the truss 112. In other words, the same technique is used as is described in FIGS. 1-8, with the exception that a larger hole saw 128 is used to drill a larger hole, such as a 1″ hole, through the truss 112. A larger bushing 124 is used to accommodate the larger diameter hole saw 128, so that the drill 122 can rotate the hole saw 128 in the bushing 124. A larger pilot rod 114 can also be used, but is not necessary. Template 137 has the appropriately sized opening for the pilot rod 115, while template 121 has an opening for the appropriate oversized bushing 125. Again, these sizes are provided by way of example only and any appropriate size hole or bolts can be used.

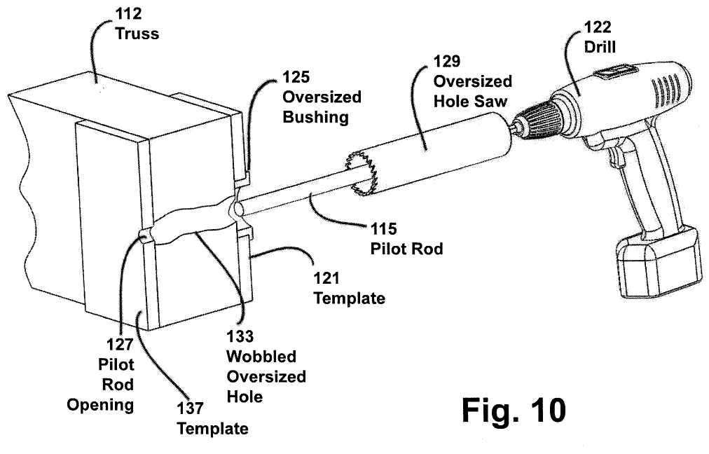

FIG. 10 is an isometric view of the embodiment of FIG. 9. As shown in FIG. 10, the oversized hole saw 129, which, in one example, may be a 1″ diameter hole saw, fits in the oversized bushing 125 in template 121. As mentioned above, the pilot rod 115 may be the same size as pilot rod 114 (FIGS. 1 and 2) or may be larger. An appropriately sized pilot rod opening 129 is formed in template 137. As mentioned above with FIGS. 1 and 2, a pilot rod opening, such as pilot rod opening 127, may constitute a plurality of openings in the template 137 that correspond to the multiple openings in metal truss connector plate 110. Again, the wobbled hole 133 is a wobbled hole made by a drill bit that is about the same size as the connecting bolt, such as connecting bolt 144 (FIG. 11), so that the wobbled hole 133 is larger than the connecting bolt 144. As such, the truss 112 is not supported by the connecting bolt 144. Oversized hole saw 129 drills a larger hole. For example, if the connecting bolt is a ¾″ diameter bolt, the oversized hole saw 129 may be a 1″ diameter hole saw that drills a single hole 112 that is centered on the centerline between the openings in the metal truss connector plates on both sides of the truss 112. The 1″ diameter hole removes all of the wobbled oversized hole 133 and creates a smooth hole with a single consistent diameter that is centered between the openings in the metal truss connector plates. Oversized bushing 125 is sized to allow the oversized hole saw 129 to rotate in the oversized bushing 125 when rotated by drill 122.

FIG. 11 is an isometric view illustrating the manner in which the oversized hole 138 can be used to center a smaller diameter connecting bolt 144 in the openings of the metal truss connector plates on both sides of the truss 112. As illustrated in FIG. 11, an insert 140 having an outer diameter that matches the oversized hole diameter 138 is inserted in the oversized hole 138. The insert 140 has an opening 141 that matches the diameter of the connector bolt 144. A washer 142 is used to allow rotation of the connector bolt 144. Insert 140 fits tightly in the oversized hole 138 and is secured by the rounded smoothed surface of the oversized hole 138. Connector bolt 144 fits in the opening 141 of the insert 140 with a tolerance that allows the bolt to easily turn in the opening 141, but is not so loose as to allow substantial movement of the connector bolt 144 in the opening 141 as it transfers direction.

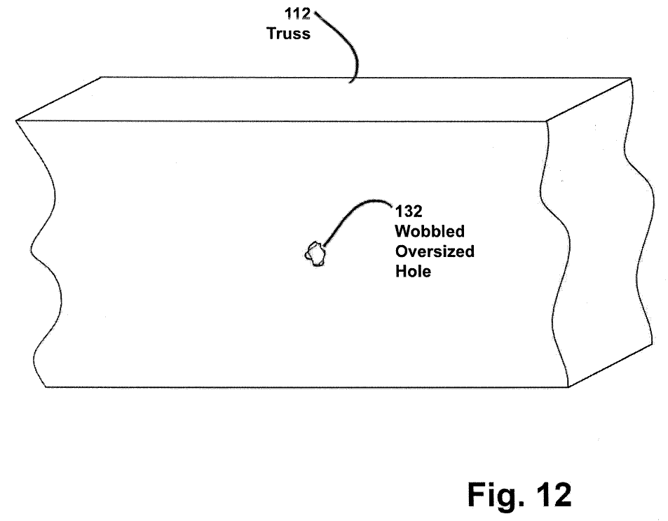

FIG. 12 is an isometric view of the truss 112. As illustrated in FIG. 12, the wobbled oversized hole 132 has a wobbled opening in the truss 112. FIG. 12 illustrates truss 112 without the template shown that has a pilot rod opening 127 that is centered on the opening for the metal truss connector plate 110.

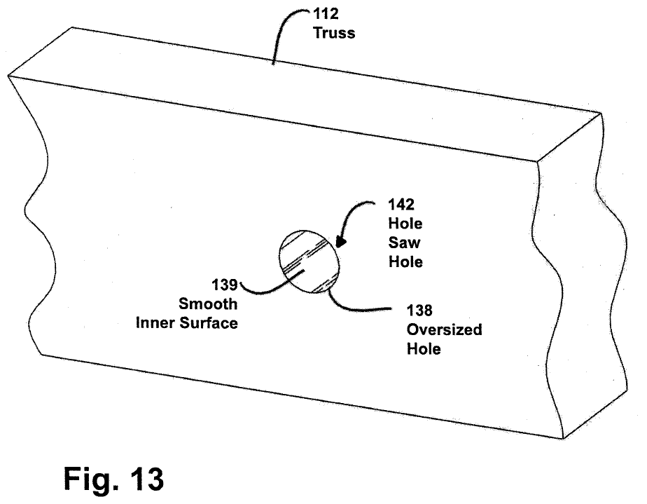

FIG. 13 is an isometric view of the truss 112 that is similar to FIG. 12, but shows the oversized hole 138 that has been sawed out around the wobbled oversized hole 132 illustrated in FIG. 12. The oversized hole 138 has a smooth inner surface 139 with a consistent diameter in which the insert 140 (FIG. 11) is placed. The smooth inner surface 139 engages the smooth outer surface of the insert 140. The smooth outer surface 141 of the insert 140 (FIG. 11) engages the smooth inner surface 139 with sufficient friction to hold the insert in place in the oversized hole 138.

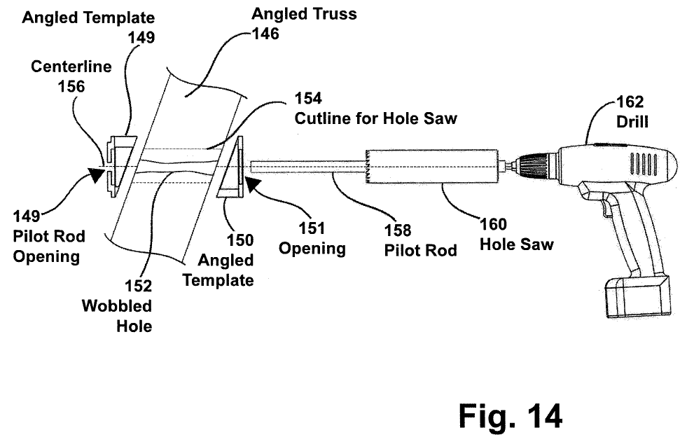

FIG. 14 illustrates another embodiment in which the present invention can be used on angled trusses, such as angled truss 146. As illustrated in FIG. 14, a wobbled hole 152 is created in the angled truss 146. The wobbled hole 152 does not provide sufficient support for a bolt that extends through each side of the angled truss 146. Angled template 148 and angled template 150 are placed on the left side and right side, respectively, of the angled truss 146 along the centerline 156 of the openings in a metal truss connector plate (not shown). Angled template 150 has an opening 151 that allows the hole saw 160 to fit through the opening 151 and rotate in the opening 151 when turned by drill 162. Pilot rod 158 extends through the wobbled hole 152 and through the pilot rod opening 149 in the angled template 148. Angled template 148 and angled template 150 are secured to the surface of the angled truss 146, as indicated above, so that the opening 151 and pilot rod opening 149 are centered on the centerline 156. In this manner, the hole saw 160 can provide a cut indicated by cutline 154 that is centered on the centerline 156 and has the correct angle with respect to the angled truss 146.

As shown, the present embodiments provide a process and tools for creating openings that are centered on a wooden structure, such as a wooden truss or beam, along a centerline that may connect openings in metal truss connector plates. The invention can also be used to create precise openings through a truss or other device for various other reasons when an opening must be created in wood or other material in a precise manner to connect other devices at a precise location on the other side of the material. The present invention discloses an embodiment in which a smaller hole can be used to insert a pilot rod to center a larger boring device, such as a hole saw, in the proper alignment with an opening on the opposite side of the material being bored. Alignment on one side of the material of the boring device and alignment of the pilot rod on the other side of the material results in a precisely cut opening along the centerline between the two sides of the material. In an alternative embodiment, holes can be corrected by sawing or boring a larger hole that is centered along a centerline and placing an insert in the oversized hole that has an opening of the proper size. Further, techniques are shown for using angled templates to create a hole through angled material using angled templates.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A tool for boring a final hole in a truss, having a final diameter, that is coaxial with a centerline between a first location on a first side of a truss and a second location on a second side of said truss comprising:
a pilot rod that has a diameter that is less than said final diameter;
a first template placed on a first side of said truss, and secured to said truss, that provides said first location on said first side of said truss;
a second template placed on a second side of said truss, and secured to said truss, that provides said second location on said second side of said truss;
a pilot bit secured to a drill that is adapted to create a wobbled hole in said truss between said first location and said second location that is sufficiently large to allow said pilot rod to extend through said wobbled hole from said first location to said second location;
a borer mounted coaxially with said pilot rod, said borer having a diameter that is the same as said final diameter, said borer adapted to bore said final hole in said truss that is coaxial with said centerline between said first location and said second location.

2. The tool of claim 1 wherein said borer is a hole saw.

3. The tool of claim 1 wherein said borer is an auger.

4. The tool of claim 1 wherein said borer is a bit.

5. A method of forming a final hole in a truss that is coaxial with a centerline between a first location, on a first side of said truss, and a second location on a second side of said truss comprising:
using a first template on said first side of said truss to place at least one opening in said template at said first location on said first side of said truss, and a second template on said second side of said truss to place at least one opening in said second location on said second side of said truss;
drilling a first pilot hole at said first location on said first side of said truss using a pilot bit, said pilot hole having a first diameter that is less than a final diameter of a final hole;
connecting said first pilot hole so that a pilot rod can extend from said first location to said second location through a wobbled hole;
extending a pilot rod, that is coaxially connected to a borer, from said first template to said second template through said wobbled hole;
placing a bushing in said first template, so that said borer is located on said centerline at said first location when said borer is located in said bushing, and said pilot rod placing said borer on said centerline of said second location when said pilot rod is located in said second template, said bushing allowing said borer to rotate and form said final hole, that is not wobbled, and has a consistent diameter in said truss.

6. The method of claim 5 wherein said first diameter and said second diameter are the same.

7. The method of claim 6 wherein said first pilot bit and said second pilot bit are the same.

8. The method of claim 7 wherein said borer is a hole saw.

9. The method of claim 7 wherein said borer is an auger.

10. The method of claim 7 wherein said borer is a bit.

11. The method of claim 5 further comprising:
drilling a second pilot hole at said second location on said second side of said truss using a second pilot bit, said second pilot hole having a second diameter that is less than said final diameter of said final hole.
